(19) United States
(12) Patent Application Publication
(10) Pub. No.: US 2010/0224738 A1
(43) Pub. Date: Sep. 9, 2010

(54) CABLE SUPPORT DEVICE

(76) Inventor: William Bourgeois, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/719,739

(22) Filed: Mar. 8, 2010

Related U.S. Application Data
(60) Provisional application No. 61/158,475, filed on Mar. 9, 2009.

(51) Int. Cl. F16L 3/08

(52) U.S. Cl. 248/70

(57) ABSTRACT

A cable support device is adapted to support electrical cable. The device supports cable in a generally horizontal position along the length of a wall, ceiling, beam or other support structure. The support device may also be attached to other structures, such as a bracket suspended from overhead structure by a hanger rod, for example.

### REFERENCE TO PRIORITY DOCUMENTS

This application claims priority of co-pending U.S. Provisional Patent Application Ser. No. 61/158,475, filed Mar. 9, 2009. Priority of the aforementioned filing date is hereby claimed and the disclosure of the Provisional Patent Application is hereby incorporated by reference in its entirety.

### BACKGROUND

This disclosure relates generally to support devices for supporting cable, and more specifically to a support device that conveniently supports cable, electrical wiring and the like in a suspended state.

When installing electrical cable in a building, a cable support device is generally used to attach the cable to a support structure such as a beam, rod, ceiling, or wall. The support device is typically in the form of a clip that has a hook at a lower end for supporting the cable. The cable must be retained in the hook to prevent the cable from slipping off of the support structure as the cable is pulled through a series of support structures. Current cable support devices are not adapted for efficient and time-effective installation of cables. One reason for this is that the hook generally has an upward open end such that, when the cable is placed in the hook, it has a tendency to fall out of the hook as the installer pulls the cable through other hooks.

### SUMMARY

In view of the foregoing, there is a need for improved cable support device for electrical and low voltage cable. Disclosed is a device that is easily and conveniently used to support cables. In one aspect, there is disclosed a cable support device, comprising: a hook member having a first vertical arm, a second vertical arm, and a horizontal arm connecting lower regions of the first and second vertical arms to collectively form a seat for cable, wherein the seat has an upper opening through which cable can be lowered into the seat; a retainer member rotatably attached to the first vertical arm, wherein the retainer member rotates between at least two positions including: (a) a closed position wherein the retainer member covers the upper opening of the seat to prevent cable from being removed from or inserted into the seat; and (b) an open position wherein the retainer member does not cover the upper opening so that cable can be removed from and inserted into the seat; and an attachment device that locks the retainer member in the closed position to prevent the retainer member from moving to the open position from the closed position.

Other features and advantages should be apparent from the following description of various embodiments, which illustrate, by way of example, the principles of the invention.

### BRIEF DESCRIPTION OF THE FIGURES

FIG. 1 shows a perspective view of an exemplary cable support device.

FIG. 2 shows an enlarged view of the attachment between a retainer member and a first arm of the device.

FIG. 3 shows a rear, perspective view of the device.

FIG. 4 shows an enlarged, perspective view of a rear of the device 105.

FIG. 5 shows another embodiment of a cable support device.

### DETAILED DESCRIPTION

Before the present subject matter is further described, it is to be understood that this subject matter described herein is not limited to particular embodiments described, as such may of course vary. It is also to be understood that the terminology used here in is for the purpose of describing particular embodiments only, and is not intended to be limiting. Unless defined otherwise, all technical terms used herein have the same meaning as commonly understood by one skilled in the art to which this subject matter belongs.

As will be apparent to those of skill in the art upon reading this disclosure, each of the individual embodiments described and illustrated herein has discrete components and features which may be readily separated from or combined with the features of any of the other several embodiments without departing from the scope of the subject matter described herein. Any recited method can be carried out in the order of events recited or in any other order which is logically possible.

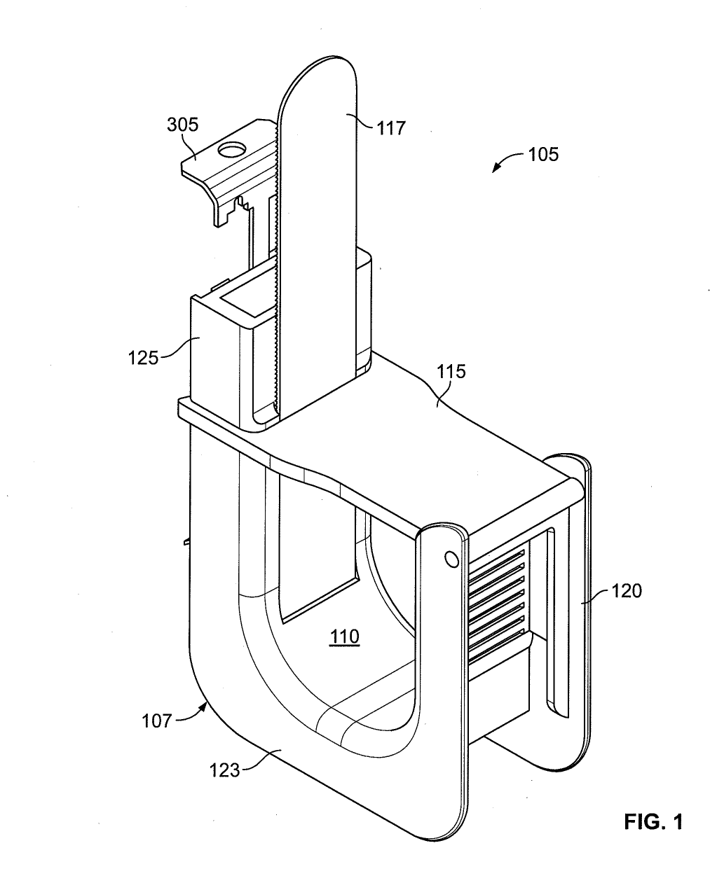

FIG. 1 shows a perspective view of a cable support device 105 that is adapted to support electrical cable. The device 105 supports cable in a generally horizontal position along the length of a wall, ceiling, beam or other support structure. The support device 105 may also be attached to other structures, such as a bracket suspended from overhead structure by a hanger rod, for example. The type of cable may vary. For example, the cable may be transmission cable (such as twisted pairs, fiber optic or innerduct), electrical wiring and the like (generally referred to in the trade as “cable” or “cabling”). In an embodiment, the device 105 may be used to support cable generally known in the trade as “category 5 cable” or CATS cable. In other embodiment, the cable is CATS, CAT6, audio, alarm, video, fiber, and/or any low voltage cable.

The device 105 generally comprises a J-shaped hook 107 that defines a seat 110 in which cable can be seated or otherwise positioned such that the cable extends lengthwise through the seat 110. The seat 110 is sized and shaped to receive and support a length of cable. A retainer member 115 is pivotably attached to a first arm 120 of the hook 107 such that the retainer member 115 can pivot to a closed position that prevents or inhibits the cable from moving upwardly out of the seat 110, as described more fully below. The retainer member 115 can conveniently be locked in the closed position after the cable has been retained in the seat 110. The device 105 further includes a strap 117 that can be wrapped around the cable for securing the cable in a bundled state in the seat 110, as described more fully below.

With reference still to FIG. 1, the J-shaped hook 107 includes a first upwardly-extending arm 120 and a second upwardly-extending arm 125 that are connected by a horizontal arm or horizontal region 123 to collectively form the seat 110. The second arm 125 is adapted to be secured to a support structure via a clip 305 that attaches to the support structure, as described in more detail below. In an embodiment, the first arm 120 has a length that is smaller than the second arm 125. It should be appreciated that the size of the device 105 can vary,

In use, the cable rests on the horizontal region 123 of the j-shaped hook 107 and is bounded on either side by the arms 120 and 125. The horizontal region 123, first arm 120, and second arm 125 collectively define the seat 110 in which the cable can be positioned. It is desirable that the cable, once positioned in the seat, be retained therein as an installer manipulates or otherwise handles the cable. In other words, it would be desirable that the cable not inadvertently fall out of the seat 110.

In this regard, the retainer member 115 is adapted to be transition between a closed position (shown in FIG. 1) that retains the cable in the seat 110, and an open position that permits the cable to be removed from the seat 110. To permit the retainer member 115 to move between the open and closed positions, the retainer member 115 is pivotably attached to the first arm 120, such as at an upper region of the first arm 120. The retainer member 115 is shown as being a generally plate-shaped member that is sized to extend across the seat 110 from the first arm 120 to the second arm 125. When in the closed position, as shown in FIG. 1, the retainer member 115 spans across the space between the first arm 120 and the second arm 125 such that it essentially covers the seat 110. When in the closed position, the retainer member 115 prevents cable from moving upwardly out of the seat 110.

The retainer member 115 can rotatably move to an open position by pivoting away from the closed position shown in FIG. 1. When in the open position, the retainer member 115 does not cover the seat 110 such that cable can be lifted out of the seat 110. That is, when in the open position, the retainer member 115 does not impede or otherwise obstruct cable from being lifted out of the seat 110. In this regard, the retainer member 115 is generally positioned parallel and adjacent to an outside surface of the first arm 120 of the J-shaped hook when in the open position. The retainer member 115 can be transitioned between the open and closed potions by a person that is installing the cable. Thus, the retainer member 115 prevents the cable from falling off of the hook as the cable is pulled through the hook during installation.

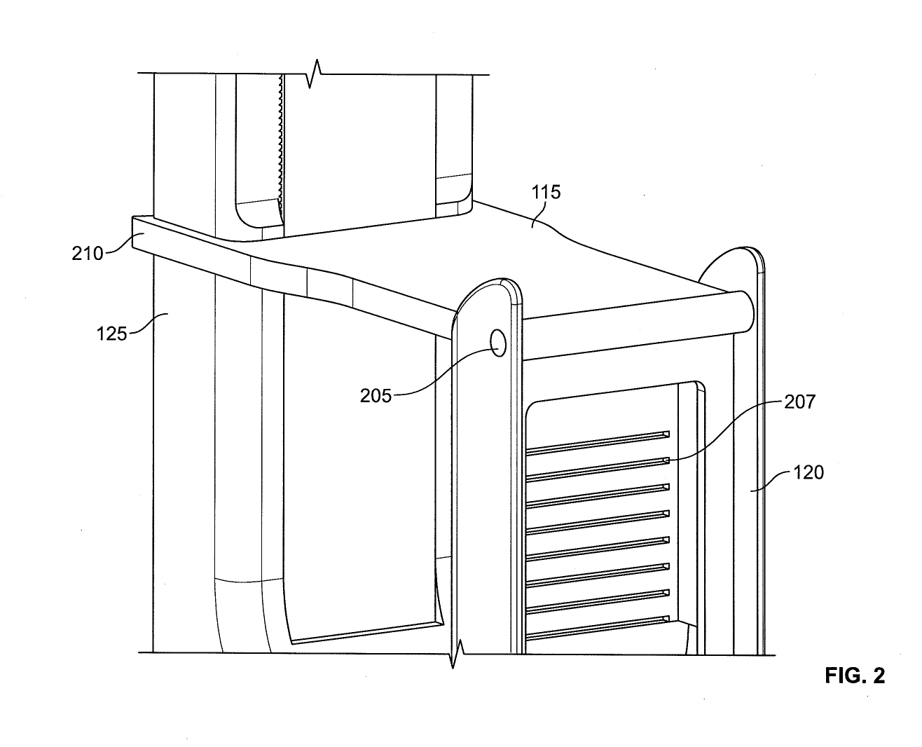

FIG. 2 shows an enlarged view of the attachment between the retainer member 115 and the first arm 120 of the hook 107. The retainer member 115 is attached to the first arm 120 via a pivot pin 205 that is attached to an end of the retainer member 115. The pivot pin 205 defines an axis of rotation about which the retainer member 115 can rotate between the open and closed positions. Thus, the pivot pin 205 and the retainer member 115 rotate about the axis of the pivot pin 205 relative to the first arm 120 as the retainer member 115 moves between the open and closed positions.

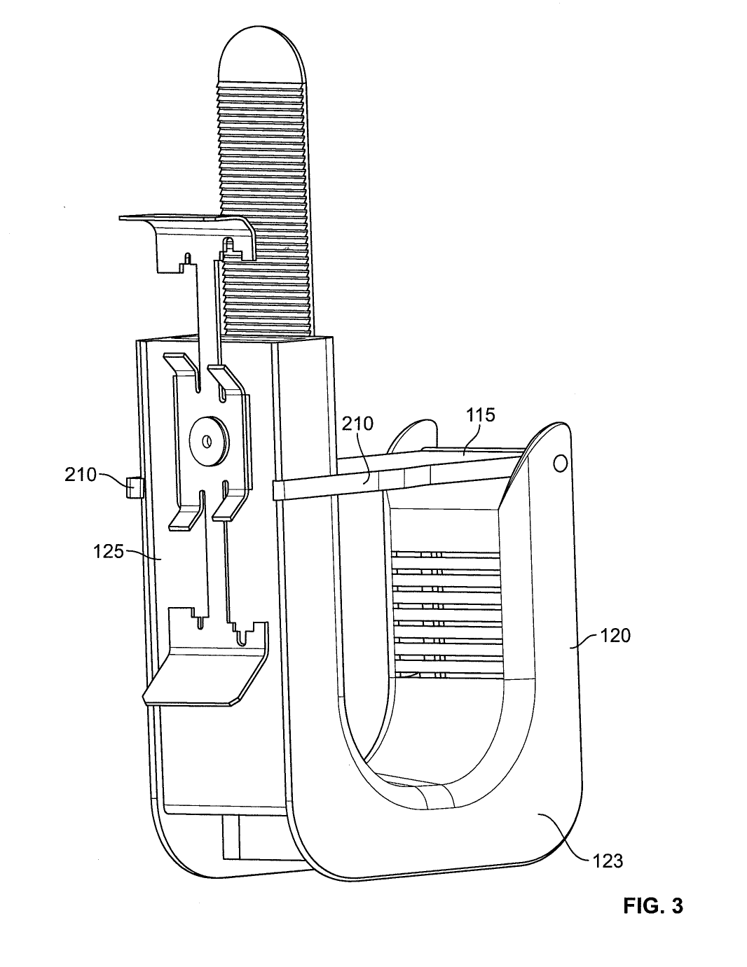

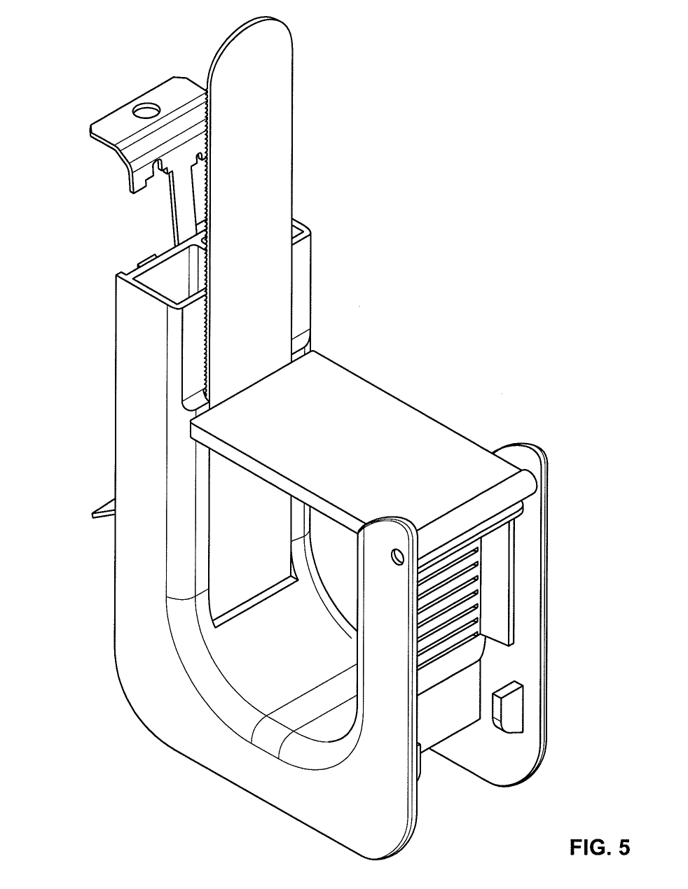

A distal end of the retainer member 115 has an attachment device or attachment means 210 that serves to secure the retainer member 115 to the second arm 125. In this manner, the retainer member 115 can be secured in the closed position so that it does not inadvertently move to the open position once it is closed. Any of a variety of structures can be used to as the attachment means 210. FIG. 3 shows a rear, perspective view of the device. As shown, the attachment means 210 can comprise a pair of arms that wrap around a portion of the second arm 125 to provide a relatively secure attachment between the retainer member 115 and the second arm 125. Any of a variety of attachment means 210 can be used to secure the retainer member 115 to the second arm 125 in the closed position. For example, FIG. 5 shows another embodiment wherein the distal end of the retainer member 115 has attachment means 210 comprised of at least one dimple that mates with at least one protrusion on the second arm 125, or vice-versa, so that the retainer member clasps in place.

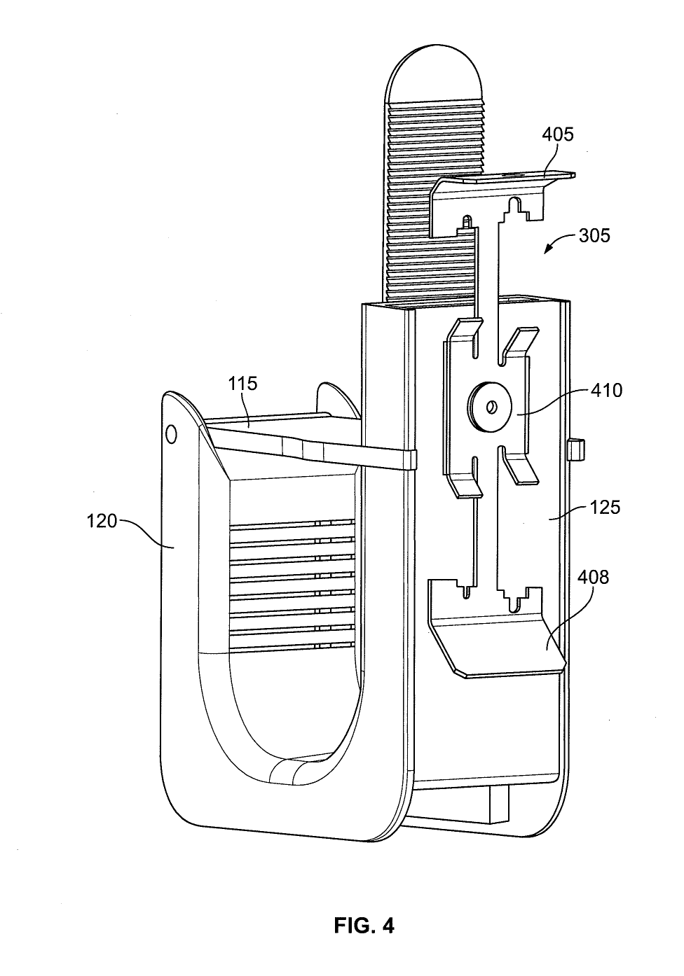

FIG. 4 shows an enlarged, perspective view of a rear of the device 105. One or more clips 305 is positioned on a rear surface of the second arm 125. The clip 305 can be used to attach the device 105 to a vertically-oriented support structure, such as a vertically-oriented beam, metal rod or metal screw in various diameter sizes. In this regard, the clip 305 includes an upper attachment 405, a lower attachment 408, and a pair of central attachments 410 that can be bent around the vertically-oriented support structure such that the clip 305 secures to the support structure. The upper attachment 405 includes an opening through which a screw or nail can be inserted to suspend the hook from a horizontal surface.

With reference again to FIG. 1, a strap 117 is attached to the second arm 125. In this regard, the strap 117 can be attached at a lower end to the seat 110 such that the strap 117 extends upwardly from the seat 110 in a cantilevered fashion. The strap 117 is a flexible piece of material that can be used to wrap around a bundle of cable positioned in the seat 110. The strap 117 is sufficiently flexible and/or malleable such that a user can manipulate the strap 117 such that it at least partially winds around the cable positioned in the seat 110 to secure the cable in a bundled state. In an embodiment, the strap is made out of polypropylene or nylon although it should be appreciated that other materials can be used for the strap.

The strap 117 is configured to attach to a portion of the first arm 120 for securing the strap in a desired position after it has been wrapped around the bundle of cable. In this regard, the first arm 120 includes one or more slots 207 (shown in FIG. 2 that are sized and shaped to receive a portion of the strap 117. In the illustrated embodiment, the slots 207 are arranged in series along the length of the first arm 120 to permit the strap 117 to be inserted into a variety of locations along the length of the first arm 120. Each of the slots 207 has a size and shape relative to the strap 117 such that a distal region of the strap 117 can be inserted through a respective slot and retained therein without the need to use any additional retaining structure. For example, when the strap 117 is inserted into a slot 207, a press fit can be achieved therebetween that secures the strap 117 in the slot 207. A self-locking mechanism can be employed, such as teeth or ridges on the strap 117 that engage corresponding teeth or ridges in the slots 207.

A method of using the device 105 is now described. An installer first attaches the device 105 to a support structure, such as to along the length of a wall, ceiling, beam or other support structure. When installed, the J-shaped hook 107 is vertically oriented such that the open end of the “J” is facing upward. The retainer member 115 is initially in the open state such that the seat 110 is open at an upward end. This permits the installer to easily place a cable or a collection of cable into the seat 110. The horizontal region 123 of the hook serves as a horizontal surface that supports the cable in a suspended state from the support structure.

After the cable has been place in the seat 110, the installer can manipulate the device 105 to provide a secure attachment between the device 105 and the cable. In this regard, the installer can wrap the strap 117 around multiple lengths of cable (if multiple lengths are present) to keep the cable in a bundled and easily manageable arrangement. Once the strap 117 has been wrapped around the bundle of cable, the installer attaches the strap 117 to the first arm 120 to secure the strap 117 and cable bundle in place in the seat 110. As mentioned, this can be accomplished by inserting the distal end of the strap 117 through one of the slots 207 to secure the strap 117 to the first arm 120.

With the cable in place in the seat 110, the installer then transitions the retainer member 115 to the closed position. The installer does this by rotating the retainer member 115 about the axis of the pivot pin 205 such that the retainer spans across the upper end of the seat 110 between the first arm 120 and the second arm 125. In this manner, the retainer member 115 essentially closes the seat 110 to prevent the cable from being lifted upward out of the seat 110. As mentioned, the retainer 117 can be locked in the closed position by engaging the distal end of the retainer with the second arm 125 using any of a variety of attachment means 210.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although embodiments of various methods and devices are described herein in detail with reference to certain versions, it should be appreciated that other versions, embodiments, methods of use, and combinations thereof are also possible. Therefore the spirit and endoscope of the appended claims should not be limited to the description of the embodiments contained herein.

What is claimed:

1. A cable support device, comprising:
a hook member having a first vertical arm, a second vertical arm, and a horizontal arm connecting lower regions of the first and second vertical arms to collectively form a seat for cable, wherein the seat has an upper opening through which cable can be lowered into the seat;
a retainer member rotatably attached to the first vertical arm, wherein the retainer member rotates between at least two positions including
(a) a closed position wherein the retainer member covers the upper opening of the seat to prevent cable from being removed from or inserted into the seat; and
(b) an open position wherein the retainer member does not cover the upper opening so that cable can be removed from and inserted into the seat; and
an attachment device that locks the retainer member in the closed position to prevent the retainer member from moving to the open position from the closed position.

2. A device as in claim 1, further comprising a strap attached to the hook member, the strap adapted to wind at least partially around a bundle of cable positioned in the seat.

3. A device as in claim 2, wherein the strap has a first end attached to the hook member and a second end that is cantilevered from the hook member.

4. A device as in claim 3, wherein the second end of the strap inserts into a slot in the first arm.

5. A device as in claim 1, wherein the second arm is longer than the first arm.

6. A device as in claim 1, further comprising a clip on the second arm for securing the device to a support structure.

7. A device as in claim 1, wherein the hook member is J-shaped.

8. A device as in claim 1, wherein the retainer member rotates about a pivot axis located at an upper end of the first arm.
